(19) United States
(12) Patent Application Publication
(10) Pub. No.: US 2008/0091595 A1
(43) Pub. Date: Apr. 17, 2008

(54) System and Method for Accessing Wages

(76) Inventors: Juan Rios, League City, TX (US); Philip J. Orth, Houston, TX (US)

Correspondence Address: JOHN K. BUCHE, 7777 FAY AVENUE, SUITE 205, LA JOLLA, CA, 92037, US

(21) Appl. No.: 11/873,096

(22) Filed: Oct. 16, 2007

Related U.S. Application Data
(60) Provisional application No. 60/852,077, filed on Oct. 16, 2006.

(51) Int. Cl. G06Q 40/00

(52) U.S. Cl. 705/39; 705/35

(57) ABSTRACT

The present application is directed to a method of enabling an employer's employee to access wages via a creditor at times other than specified pay periods, comprising: a creditor providing a line of credit to the employee via an agreement with the employer whereby the employer agrees to pay any loan made to the employee by the creditor; the employee receiving a loan from the creditor creating a debt owed to the creditor; the employer deducting from one or more future specified pay periods a portion of the employee's wages including at least a portion of the debt amount and a processing fee amount; and the employer transferring to the creditor (1) the deducted wage amount and (2) a portion of the processing fee.

### CROSS-REFERENCE TO RELATED APPLICATIONS

The application is entitled to the benefit of the filing date of the prior-filed provisional application No. 60/852,077, filed on Oct. 16, 2006.

### STATEMENT REGARDING FEDERALLY SPONSORED RESEARCH OR DEVELOPMENT

Not applicable.

### FIELD OF THE APPLICATION

The application relates generally to a system and method for employees to access their wages at times other than specified pay periods.

### BACKGROUND

Employees that are paid on a weekly basis benefit by having access to their wages on a regular basis. Employees that are not paid weekly, i.e., biweekly, monthly, quarterly, etc., may not have access to their wages outside of their specified pay periods. As a result, an employee may not be able to access funds during a time of emergency, if the funds are desired at a time other than a specified pay period.

Accordingly, there is a need for a mechanism by which employees may access their wages at times other than specified pay periods.

### SUMMARY

The present application is directed to a method of enabling an employer's employee to access wages via a creditor at times other than specified pay periods, comprising: a creditor providing a line of credit to the employee via an agreement with the employer whereby the employer agrees to pay any loan made to the employee by the creditor; the employee receiving a loan from the creditor creating a debt owed to the creditor; the employer deducting from one or more future specified pay periods a portion of the employee's wages including at least a portion of the debt amount and a processing fee amount; and the employer transferring to the creditor (1) the deducted wage amount and (2) a portion of the processing fee.

The present application is also directed to a method for an employer to pay an employee's debt owed to a creditor, comprising: a third party brokering an agreement between the creditor and the employer, said agreement including (1) the creditor promising to create an account for the employee whereby the creditor provides a line of credit to the employee and transfers to the employer a portion of any interest accrued on the debt amount, and (2) the employer promising to pay any future debt owed to the creditor on said account and a portion of a processing fee collected from the employee; the employee entering into an agreement with the employer to be bound by the agreement between the creditor and the employer; the employee receiving a credit card from the creditor; the employee using the credit card thereby creating a debt owed to the creditor; the employer deducting from one or more future specified pay periods a portion of the employee's wages including at least a portion of the debt amount and a processing fee amount; the employer transferring to the creditor (1) the deducted wage amount and (2) a portion of the processing fee; and the employer transferring to the third party a portion of the processing fee.

The present application is also directed to a system for enabling an employer's employee to access wages via a creditor at times other than specified pay periods, comprising: an agreement between the employer and the creditor whereby the employer provides employees with the opportunity to receive a line of credit from the creditor, said agreement brokered by a third party; an enrollment means whereby the creditor provides a line of credit to an employee; a lending means whereby the creditor transfers funds to the employee thereby creating a debt owed to the creditor; a deduction means whereby the employer deducts a portion of the employee's wages during a specified pay period including (1) at least a portion of the debt amount and (2) a processing fee; and a payment means whereby the employer transfers to the creditor the deducted wage amount and a portion of the processing fee amount, and transfers to the third party a portion of the processing fee.

### BRIEF DESCRIPTION OF THE FIGURES

FIG. 1 is a flow chart illustrating certain embodiments of the present invention.

### BRIEF DESCRIPTION

It has been discovered that employees may access their wages via a creditor at times other than specified pay periods, while simultaneously creating a revenue stream for the creditor, for the employee's employer, and possibly for a third party broker based on loans made to the employee via the creditor. Heretofore, such a desirable achievement has not been considered possible, and accordingly, the system and method of this application measure up to the dignity of patentability and therefore represents a patentable concept.

Before describing the invention in detail, it is to be understood that the present system and method are not limited to particular embodiments. It is also to be understood that the terminology used herein is for the purpose of describing particular embodiments only, and is not intended to be limiting. As used in this specification and the appended claims, the terms “lender”, “creditor, “financial institution”, “finance company”, “lending institution”, “depository institution”, “credit card company”, “bank”, and “credit union” may be used interchangeably to mean any person, organization, company or government entity that makes loans. The term “employer” means any individual, company, corporation, partnership, limited liability company, domestic or foreign, and any local or state agency, and national government employing full-time employees, part-time employees, contract employees, salaried employees, and per hour employees. The term “employee” herein refers to an individual who works part time or full time under a contract of employment, salaried or on a per hour basis, whether oral or written, express or implied, and has recognized rights and duties assigned by his/her employer. The phrase “billing cycle” herein refers to an interval between a creditor's periodic billings made or sent out to a debtor. The phrase “specified pay period” herein refers to a transfer of money on a particular calendar date from an employer to an employee for wages earned.

In one aspect, the application provides a system by which employers provide employees access to future wages.

In another aspect, the application provides a system creating a revenue stream for an employer by providing employees access to future wages.

In another aspect, the application provides a system creating a revenue stream for a creditor without any expenditures on the part of the creditor as to ascertaining customers.

In another aspect, the application provides a system creating a revenue stream for a third party broker that locates and enters an employer into an agreement with a creditor whereby the creditor agrees to offer credit to an employee of the employer and whereby the employer agrees to pay the employee's debt on a loan made to the employee by the creditor.

In another aspect, the application provides a system whereby an employer guarantees to make payments on outstanding employee credit balances held by a creditor.

In another aspect, the application provides a system whereby an employer makes payments on outstanding employee credit balances held by a creditor by deducting from one or more future paychecks of the employee a maximum agreed to dollar amount until the employee's debt is paid in full.

In another aspect, the application provides a system enabling employees to access future wages by using a credit card and/or debit card issued by a creditor.

In another aspect, the application provides a method in which an individual employee may enhance his/her personal credit by agreeing to allow his/her employer to pay a debt owed to a creditor by deducting his/her future wages to pay towards the outstanding debt balance.

In another aspect, the application provides a method in which an employee may initiate personal credit by agreeing to allow his/her employer to pay the debt owed to a creditor by deducting his/her future wages to pay a loan owed to the creditor.

In another aspect, the application provides a system whereby an employee may increase his/her available line of credit by having his/her employer transfer earned wages and/or future wages into an account of the employee held by a creditor.

In another aspect, the application provides a system whereby an employee may receive a line of credit regardless of the employee's creditworthiness.

In another aspect, the application provides a system whereby an employer makes one or more timely payments on a debt of an employee thereby enhancing the payment history of the employee.

### Discussion of the System and Method

To better understand the novelty of the system and method of use thereof, reference is hereafter made to the accompanying drawing. Generally, a simplified system is provided whereby one or more employees may access their wages via a creditor at times other than specified pay periods while also creating a revenue stream for a creditor and the employer of the one or more employees based on loans made to each employee via the creditor.

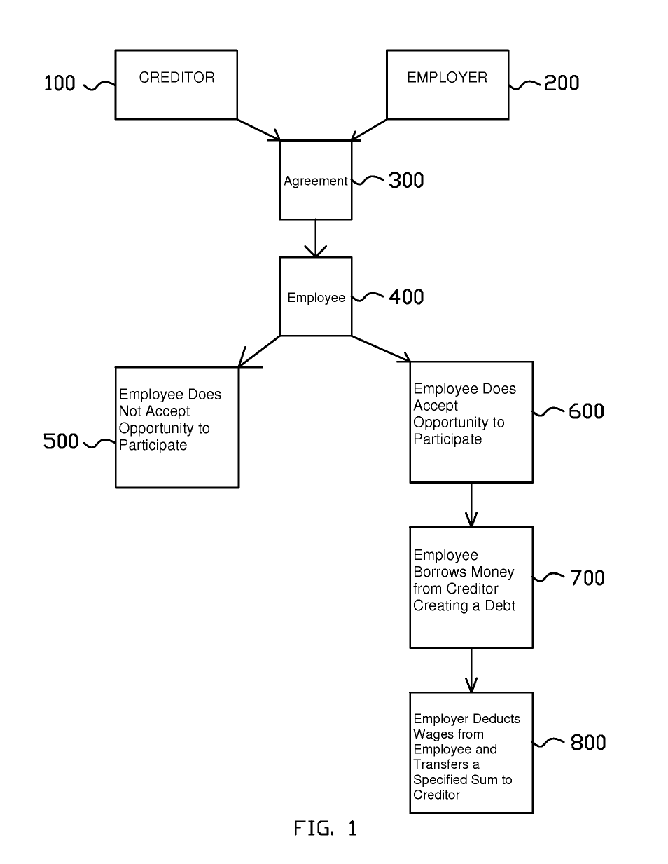

With reference now to a simplified illustration of the invention as provided in FIG. 1, a creditor 100 and an employer 200 enter into an agreement 300 whereby the creditor 100 agrees at least to provide a line of credit to one or more employees 400 of the employer 200, and the employer 200 agrees at least to pay any debt owed to the creditor 100 by the one or more employees 400. In another embodiment of the invention, the parties may enter into the agreement 300 via a third party broker that receives a fee for services rendered to the creditor 100 and/or employer 200 by bringing the parties together contractually. Under either scenario, the employer 200 agrees to pay any debt of a current employee 400 owed to the creditor 100. In another embodiment, the employer 200 may act as a guarantor on any loan made by the creditor 100 to a current or former employee 400 of the employer 200. Therefore, the present system and method creates an opportunity whereby an employee 400 may access wages via a creditor 100 regardless of the employee's 400 creditworthiness.

Once the parties have entered into the agreement 300, the employer 200 may then make the credit opportunity available to one or more employees 400. If an employee 400 decides not to accept the opportunity to participate 500, then no further steps are taken. If an employee 400 does accept the opportunity to participate 600 and agrees to be bound by the terms of the agreement 300, then steps are taken to establish a line of credit for the employee 400 with the creditor 100.

Once an account and a line of credit are established for an employee 400 by the creditor 100, the employee 400 may then borrow up to the credit limit on the account 700. Once an employee 400 has borrowed an initial dollar amount from the creditor 100, thereby creating a debt on the employee's 400 account, the employee's employer 200 may begin deducting wages from the employee's 400 future pay, and transfer to the creditor 100 from the deducted wages (1) a sum necessary to reduce or eliminate the employee's 400 debt owed to the creditor, and (2) a portion of a processing fee 800.

### The Agreement

For the purposes of this application, the parties to the underlying agreement 300 may include the creditor 100, employer 200 and employee 400 only, or in the alternative, the agreement 300 may further include a third party broker responsible for introducing the creditor 100 to the employer 200. Although the agreement 300 is not necessarily limited to any particular terms and conditions, in a first embodiment, the parties may agree to one or more of the following terms and conditions:

Creditor—(1) the creditor 100 may agree to establish a line of credit for employees 400 of the employer 200; (2) the creditor 100 may agree to limit the amount of credit offered to a particular employee 400 to a dollar amount agreed to by the employer 200; (3) the creditor 100 may agree to accept payment toward any employee 400 debt directly from the employer 200; (4) the creditor 100 may agree to accept payment toward the employee 400 debt directly from the employee 400; (5) the creditor 100 may agree that the employer 200 retain a portion of any processing fees collected by the employer 200 from the employee 400; (6) where credit cards are to be issued to the employees 400, the creditor 100 may agree to pay a fee to the employer 200 for each credit card issued to an employee 400, and pay a fee annually for each active credit card held by an employee; (7) the creditor 100 may agree to transfer a portion of any interest collected on a debt to the employer 200; (8) the creditor 100 may agree to transfer a portion of any interest collected on an employee account having a positive balance to the employee 400; (9) the creditor 100 may agree to pay a fee to a third party broker for each credit card issued to an employee 400; and (10) the creditor 100 may agree to transfer a portion of any interest collected on a debt to the third party broker.

Employer—(1) the employer 200 may agree to gather any necessary information concerning any participating employees 400 that is then to be forwarded to the creditor 100 for establishing an account and a line of credit for each employee 400; (2) the employer 200 may agree to deduct an initial set-up fee and/or annual service fee from the wages of each participating employee 400; (3) the employer 200 may agree to collect a processing fee and distribute a portion of the fee to the creditor 100 and/or to a third party, if applicable; (4) the employer 200 may agree to deduct from the wages of the participating employees 400 a maximum dollar amount agreed to by each participating employee 400 during a specified billing cycle of a creditor 100; (5) the employer 200 may agree to timely transfer to the creditor 100 a portion of the deducted wage amount for an employee 400; (6) where credit cards are to be issued to the employees 400, the employer 200 may agree to pay a fee to the creditor 100 for each credit card issued to an employee 400, and pay a fee annually for each active credit card held by an employee; (7) when credit cards are to be issued to the employees 400, the employer 200 may agree to pay a fee to the third party broker for each credit card issued to an employee 400; (8) the employer 200 agrees to periodically, i.e., monthly, update the creditor 100 as to the employment status of each participating employee 400; and (9) the employer 200 may agree to guaranty any loan made by the creditor 100 to the employee 400.

Employee—(1) the employee 400 may agree to provide information concerning himself/herself directly to the creditor 100 for establishing an account and a line of credit for the employee 400; (2) the employee 400 may agree to an initial set-up fee, processing fee and an annual service fee to be deducted from the employees 400 wages by the employer 200; (3) the employee 400 may agree that any line of credit offered to the employee 400 will be limited to a specific dollar amount as agreed upon between the creditor 100 and the employer 200; (4) the employee 400 may agree and authorize the employer 200 to deduct wage amounts and processing fee amounts from one or more specified pay periods; (5) the employee 400 may agree to terms and conditions established by the creditor 100 in creating the employee's 400 account including, but not necessarily limited to annual percentage interest rates, variable interest rates, any rewards program such as cash back, frequent flyer miles, etc.; (6) the employee 400 may agree to be responsible for a portion of any debt owed to the creditor 100 and not paid by the employer 200; (7) the employee 400 may agree to allow the employer 200 to deduct wage amounts other than debt amounts in order to create a positive balance in the employee's 400 account; (8) the employee 400 may agree that if his/her account carries a zero account balance, then no money may be borrowed on his/her account until a positive account balance is established; (9) the employee 400 may agree to be charged interest on any outstanding balance; and (10) the employee 400 may agree to pay the remainder of any outstanding balance owed on the account once employment through the employee 400 ceases—regardless of termination or resignation.

As previously stated, a third party broker or other outside entity may receive a fee for bringing a particular employer and creditor together contractually under the above described agreement 300. Suitably, any fee paid to a third party broker is subtracted from the processing fee and/or the annual service fee. In another embodiment, any fee paid to a third party broker may be derived from funds other than processing and service fees. For example, a fee paid to a third party broker may include, (1) a specified dollar amount per each employee 400 that is issued a line of credit under the agreement 300, (2) a percentage of the line of credit itself, (3) a percentage of each processing fee that is deducted from the one or more specified pay periods, (4) an annual fixed fee amount for each employee 400 participating, (5) a percentage of the loan amount for a specified pay period for each employee 400, (6) where credit cards are issued to the employees 400, a fixed fee for each active credit card, and combinations thereof. Regardless of the mode of payment to a third party, by participating under the terms of the agreement 300, the employee 400 agrees that deducted wages may be used to pay fees to a third party broker by the creditor 100 and/or the employer 200.

Suitably, the line of credit made available to an employee 400 by a creditor 100 may be determined by any number of factors. In one embodiment, the line of credit may be established as a percentage of the employee's salary or per hour earnings. For example, the line of credit may be established as a percentage of the employee's wages for a specified pay period. In another embodiment, the line of credit may be established as a fixed amount regardless of the employee's wages for a specified pay period. Other factors that may determine an employee's line of credit may include, but are not necessarily limited to an employee's years of service with the employer, an employer's creditworthiness, and combinations thereof.

In a particularly advantageous embodiment, the line of credit for a particular employee 400 is determined not considering the employee's 400 creditworthiness, whereby the line of credit is determined based on the employee's total wages for a specified pay period and the number of years the employee 400 has been employed by the employer 200. In addition, the number of years of employment for a particular employee 400 may assist the creditor 100 in determining the level of risk for that employee 400, if and when employment ceases—whereby the employee 400, not the employer 200, is responsible for paying any outstanding balances on the employee 400 account held by the creditor 100. Depending on the risk determination, the creditor 100 may or may not continue to offer a line of credit to a former employee. In addition, a creditor 100 may change the terms and conditions for former employs if continued credit is offered following employment. Suitably, if there is an outstanding balance owed on an employee 400 account once an employee 400 is either terminated or resigns, the outstanding debt becomes the sole responsibility of the former employee 400, unless otherwise agreed to under the terms of the agreement 300.

The level of risk for a particular employee may also be determined by information other than any background information provided to the creditor 100 by the employer 200. For instance, the creditor 100 may gather any information concerning the employee 400 necessary for the creditor 100 to determine the level of risk of a particular employee 400 following employment by the employer 200. Suitable employee 400 information may include, but is not necessarily limited to the employee's adjusted gross income, the employee's household income, the employee's credit score, and combinations thereof.

Suitably, an employee 400 may borrow up to the credit limit on his/her account between any two specified pay periods. For example, if an employee 400 has a line of credit of $1000.00, and borrows $1000.00 in a single transaction, then the employee 400 is not permitted under the agreement 300 to borrow any more money from the creditor 100 until the employer 200 and/or the employee 400 has made at least one payment toward the outstanding balance on the employee's 400 account. At which point, the employee 400 may then only borrow up to the available credit limit on the account.

As previously stated, under the agreement 300 the employer 200 may agree to make payments to the creditor 100 on an employee's debt, i.e., outstanding account balance, up to an agreed maximum dollar amount per billing cycle. In one embodiment, the maximum dollar amount payable to the creditor 100 may include a maximum fixed dollar amount. For example, an employer 200 may agree to pay a maximum of $200.00 during any one creditor billing cycle. If the outstanding balance for an employee 400 during a particular billing cycle is $190.00, e.g., the employee 400 uses an issued credit card to make a $190.00 purchase, then the employer 200 will deduct the full $190.00, plus any processing fee, from the employee's wages and transfer this amount to the creditor 100. In another example, if the outstanding balance for an employee 400 during a particular billing cycle is $210.00, then the employer will deduct only the $200.00 maximum amount, while the remaining $10.00 in the employee's account may be subject to interest charges by the creditor 100.

In another embodiment, the maximum dollar amount payable to the creditor 100 may include a percentage of the outstanding principal balance on the employee's account held by the creditor 100. In another embodiment, the maximum amount payable to the creditor 100 may include a percentage of the total of the outstanding principal balance plus any accrued interest, i.e., outstanding debt amount, for a specified pay period. Although not limited to a particular percentage rate, it is herein contemplated that up to about 25.0% of an employee's wages may be deducted by an employer 200 during (1) any specified pay period, or (2) during any one billing cycle of the creditor 100.

In addition to any loan amounts deducted from an employee's 400 wages, the fees that may be deducted from an employee's 400 wages may include, but are not necessarily limited to initial set up fees, processing fees, annual membership fees, renewal type fees, credit and/or debit card issuance fees, credit and/or debit card transaction fees, and combinations thereof. In an embodiment where a line of credit is issued to an employee 400, but no credit/debit card is issued to an employee 400, the fees that may be deducted from an employee's wages include, but are not necessarily limited to an initial set up fee, a processing fee, and an annual participation fee. In an embodiment where a credit card and/or debit card is issued to an employee 400, additional fees may also be deducted from the employee's wages including, but not necessarily limited to credit/debit card issuance fees, transaction fees, annual maintenance fees, and combinations thereof. Suitably, initial set up fees cover costs associated with the creditor 100 establishing an account for an employee 400 and costs incurred by the employer 200 associated with enrolling an employee 400 into the system. The above described processing fees may include, but are not necessarily limited to fees to cover costs associated with transferring wage amounts from the employer 200 to the creditor 100, and transferring wage amounts from the employer 200 to a third party broker.

It is herein contemplated that the initial set up fees, annual membership fees, renewal fees, and credit/debit issuance fees may include any fixed dollar amount as agreed to between the parties. For example, an initial set up fee for an employee 400 may cost $5.00, the annual membership fee may cost $10.00, and the credit/debit card issue fee may cost $5.00 for each card issued, as well as a $3.00 annual fee for each active credit card held by a current employee 400. Other processing fees and credit and/or debit card transaction fees may include fixed dollar amounts or in the alternative, these fees may include a percentage of a particular loan amount, a percentage of an outstanding balance owed on the employee's account, a percentage of an amount deducted from an employee's wages during a billing cycle, and combinations thereof.

It is also contemplated herein that each of the deducted fee amounts may be distributed between the creditor 100, employer 200, and any third party as set out in the agreement 300. Likewise, any accrued interest may be distributed amongst the parties as agreed upon. For example, the agreement 300 may divide any and all fees amongst the creditor 100, employer 200 and any third party on a percentage basis. In another embodiment, the creditor 100 and employer 200 may pay any third party a fixed dollar amount from the collected fees, while the remaining portion of the fees is distributed amongst the creditor 100 and employer 200 on a percentage basis.

Generally, any interest is to be charged to an employee's 400 account using methods common to the lending industry. For example, an employee 400 may be subject to either a fixed or variable interest rate. Depending on the terms of the agreement 300, a creditor 100 may maintain any accrued interest amount. In another embodiment, any accrued interest amounts may be distributed amongst the creditor 100 and the employer 200 on a percentage basis. In one particular embodiment, the creditor 100 may transfer an actual dollar amount to the employer 200 representing a percentage of an accrued interest amount on an employee's 400 outstanding account balance. In another particular embodiment, the employer 200 may retain a portion of the employee's 400 deducted wages in the form of a fee representing any accrued interest on an employee's 400 outstanding account balance. It is also herein contemplated that the creditor 100 and/or employer 200 may transfer to a third party broker a dollar amount representing any accrued interest on an employee's 400 outstanding account balance.

Depending on the terms and conditions of the agreement 300, an employee 400 may be allowed to establish a positive account balance by transferring wages and/or other personal funds directly into his/her account held by the creditor 100. Thus, the system and method of this application may further include a transfer means by which an employee 400 may direct his/her employer 200 to (1) deduct a specified wage amount, other than a debt amount owed to the creditor 100, during one or more future specified pay periods and (2) transfer the deducted amount to the creditor 100. The transfer means may include written, verbal, or electronic instructions from the employee 400 to the employer 200 permitting any future wage deductions. In another embodiment, an on-line system may be established whereby an employee 400 may access his/her account under the agreement 300 and (1) input the wage deduction instructions to the employer 200 via computer, or (2) transfer funds from one or more outside sources directly into the employee account held by the creditor 100.

The invention will be better understood with reference to the following non-limiting example, which is illustrative only and not intended to limit the present invention to a particular embodiment.

### EXAMPLE 1

In a first non-limiting example, a method of enabling employees to access wages via a creditor at times other than specified pay periods is accomplished by the following steps:
(1) A third party broker contacts a bank (“Bank A”) willing to offer credit, including credit cards, to an employer's employees without performing a credit check of the employees (the “Employee Opportunity”);
(2) The third party broker enters into an agreement with Bank A whereby the third party broker agrees to present employers to Bank A and Bank A agrees to share with the third party broker any revenue generated under the Employee Opportunity;
(3) The third party broker contacts a corporate employer willing to provide its employees with the Employee Opportunity whereby employees receive credit from Bank A while having future wages deducted to pay any outstanding balance owed to Bank A based on any loans made by Bank A to an employee;
(4) The employer enters into an agreement with Bank A and the third party broker to make the Employee Opportunity available to its employees. Under the agreement, the employer guarantees a timely 25% minimum payment on the outstanding credit card account balances for each of its employees; Bank A is guaranteed to receive 12.0% per annum on any outstanding credit card account balance owed; Bank A guarantees to pay the employer 2.0% of the 12.0% on each outstanding credit card account balance owed; the employee agrees that the employer may deduct an initial fee of $8.00 upon participation in the Employee Opportunity, followed by an $8.00 fee to be deducted annually and divided as follows: (a) the employer guarantees to pay to Bank A $2.00 per active credit card issued for each employee, (b) the employer retains $2.00, and (c) the employer guarantees to pay the third party broker $4.00 per active credit card issued for each employee.
(5) The employer notifies its employees of the Employee Opportunity;
(6) One or more employees accept the Employment Opportunity and enter into agreements with their employer including terms and conditions such as (a) mode of wage deduction to pay off debts owed to Bank A, (b) the initial set-up fees and (c) annual fees charged to each participating employee;
(7) Each employee provides basic background information regarding annual earnings from the employer, the number of years employed by the employer, and the employee's job title and/or job description to Bank A;
(8) Bank A establishes an account for each employee including issuing a credit card to each employee, each credit card account having a maximum credit limit determined by the background information provided by the employee;
(9) Employee X having a maximum credit limit of $1,000.00 uses the credit card for the total amount of $1000.00.
(10) On a predetermined closing date, Bank A submits a bill to the employer for Employee X's outstanding balance of $1,000.00.
(11) Employer deducts $250.00 from Employee X's paycheck;
(12) Employer transfers $250.00 to Bank A, reducing Employee X's outstanding balance to $750.00—which is subject to interest at 12.0% per annum;
(13) At the time of the next billing cycle, Employee X's outstanding balance totals $770.00;
(14) Employer deducts $192.50, i.e., 25%, from Employee X's paycheck and transfers $192.50 to Bank A;
(15) Bank A transfers to the Employer 40 cents—based on the 2.0% of the 12.0% interest returned to the Employer.
(16) The Employer continues to deduct 25% of Employee X's wages each billing cycle, transferring each deducted amount to Bank A until Employee X's account balance is zero; Bank A continues to transfer to Employer 2% of any accrued interest for each billing cycle;
(17) Once a month, Employer sends Bank A information regarding (a) new employees that have accepted the Employment Opportunity, and (b) those participating employees whose employment has ended during the past month.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A method of enabling an employer's employee to access wages via a creditor at times other than specified pay periods, comprising:
a creditor providing a line of credit to the employee via an agreement with the employer whereby the employer agrees to pay any loan made to the employee by the creditor;
the employee receiving a loan from the creditor creating a debt owed to the creditor;
the employer deducting from one or more future specified pay periods a portion of the employee's wages including at least a portion of the debt amount and a processing fee amount; and
the employer transferring to the creditor (1) the deducted wage amount and (2) a portion of the processing fee.

2. The method of claim 1, wherein the debt amount includes a principal amount and an interest amount.

3. The method of claim 2 further comprising the creditor forwarding a portion of the interest amount to the employer.

4. The method of claim 1 further comprising the creditor providing the employee a credit card.

5. The method of claim 1 further comprising a third party brokering the agreement between the creditor and the employer.

6. The method of claim 5, whereby a portion of the processing fee is transferred to the third party.

7. The method of claim 1, whereby the line of credit is limited to a percentage of the employee's wages for a specified pay period.

8. The method of claim 1, whereby the portion of the employee's wages deducted during a specified pay period is a percentage of the outstanding debt amount for that specified pay period.

9. The method of claim 1, whereby the employee may increase the line of credit by authorizing the employer to (1) deduct a specified wage amount from one or more future specified pay periods and (2) transfer the one or more amounts to the creditor thereby creating a positive employee account balance.

10. The method of claim 9, wherein the employee receives an interest payment from the creditor based on the positive account balance.

11. The method of claim 1, whereby the employee may make payments toward the debt owed to the creditor by transferring funds directly to the creditor from one or more outside sources.

12. A method for an employer to pay an employee's debt owed to a creditor, comprising:
a third party brokering an agreement between the creditor and the employer, said agreement including (1) the creditor promising to create an account for the employee whereby the creditor provides a line of credit to the employee, and (2) the employer promising to pay any future debt amount owed to the creditor on said account and a portion of a processing fee collected from the employee;
the employee entering into an agreement with the employer to be bound by the agreement between the creditor and the employer;
the employee receiving a credit card from the creditor;
the employee using the credit card thereby creating a debt owed to the creditor;
the employer deducting from one or more future specified pay periods a portion of the employee's wages including at least a portion of the debt amount and a processing fee amount;
the employer transferring to the creditor (1) the deducted wage amount and (2) a portion of the processing fee; and
the employer transferring to the third party a portion of the processing fee.

13. The method of claim 12, wherein the debt amount includes a principal amount and an interest amount.

14. The method of claim 13, further comprising the creditor forwarding a portion of any interest accrued on the debt amount to the employer.

15. The method of claim 12, whereby the employee agrees to assume personal responsibility for paying any debt owed to the creditor if employment through the employer ceases.

16. The method of claim 12, whereby the portion of the employee's wages deducted during a specified pay period includes a percentage of the employee's wages for that specified pay period.

17. A system for enabling an employer's employee to access wages via a creditor at times other than specified pay periods, comprising:
an agreement between the employer and the creditor whereby the employer provides employees with the opportunity to receive a line of credit from the creditor, said agreement brokered by a third party;
an enrollment means whereby the creditor provides a line of credit to an employee;
a lending means whereby the creditor transfers funds to the employee thereby creating a debt amount owed to the creditor;
a deduction means whereby the employer deducts a portion of the employee's wages during a specified pay period including (1) at least a portion of the debt amount and (2) a processing fee; and
a payment means whereby the employer transfers to the creditor the deducted wages and a portion of the processing fee, and also transfers to the third party a portion of the processing fee.

18. The system of claim 17, whereby the debt amount includes a principal amount and an interest amount.

19. The system of claim 18, whereby the creditor forwards a portion of any interest accrued on the debt amount to the employer.

20. The system of claim 18, whereby the portion of the employee's wages deducted during a specified pay period is a percentage of the outstanding debt amount owed at the time of disbursement of the employee's wages.
